(19) United States
(12) Patent Application Publication
(10) Pub. No.: US 2026/0206737 A1
(43) Pub. Date: Jul. 23, 2026

(54) METHOD FOR DETECTING AND TREATING PLANTS, AND PLANT TREATMENT DEVICE

(71) Applicant: Continental Reifen Deutschland GmbH, Hannover (DE)

(72) Inventors: Martin Pöttcher, Gross-Zimmern (DE); Jonas Degener, Egelsbach (DE); Rano Lebrun, Klingenberg am Main (DE)

(73) Assignee: Continental Reifen Deutschland GmbH, Hannover (DE)

(21) Appl. No.: 19/141,386

(22) PCT Filed: Dec. 15, 2023
(86) PCT No.: PCT/DE2023/200256

§ 371 Date: Jun. 20, 2025

(30) Foreign Application Priority Data
Dec. 20, 2022 (DE) 10 2022 213 980.1

(51) Int. Cl. A01M 7/00; A01B 39/18; A01M 21/04; G06V 10/143; G06V 20/10

(52) U.S. Cl. CPC A01M 7/0089; A01B 39/18; A01M 21/043; G06V 10/143; G06V 20/188

(57) ABSTRACT

A method for detecting and treating plants by means of a plant treatment device,
wherein the plant treatment device comprises at least one camera module and at least one treatment module and an electronic control unit,
wherein at least one image of at least one or more individual plants is captured by means of the camera module,
after which, on the basis of the image of the at least one individual plant and by means of stored plant information, a decision is made in the electronic control unit for each individual plant detected
as to whether this is a useful plant or a non-cultivated plant,
and wherein at least one item of position information is assigned to this individual plant, after which, by means of the treatment module, for each non-cultivated plant detected, a liquid is applied to and/or sprayed onto the non-cultivated plant by means of at least one nozzle of the treatment module.

This application is a National Stage Application under 35 U.S.C. § 371 of International Patent Application No. PCT/DE2023/200256 filed on Dec. 15, 2023, and claims priority from German Patent Application No. 102022213980.1 filed on Dec. 20, 2022, the disclosures of which are herein incorporated by reference in their entireties.

### BRIEF SUMMARY

The invention relates to a method according to the preamble of claim 1 and a plant treatment device.

The object of the invention is to propose a method for weed removal or weed suppression, which is relatively environmentally friendly and/or cost-effective and/or highly automated and/or precise.

This object is achieved according to the invention by the method as claimed in claim 1 and the plant treatment device as claimed in claim 12.

A non-cultivated plant is preferably understood to be a weed plant.

It is preferred that the liquid has or is water at a temperature of at least 90° C., in particular at least 100° C. Particularly preferably, the liquid and/or the water is sprayed and/or applied to the detected and assessed/detected weeds at a pressure between 0.5 bar and 5 bar, in particular by means of one or more nozzles.

The liquid preferably additionally has a foam, which is in particular biodegradable and/or substantially non-toxic. The foam is particularly preferably sprayed or applied after the water.

It is preferred for the position information about each individual plant detected to comprise two-dimensional position information and additional height information about the treatment module above the ground on which the plants stand, or three-dimensional position information.

It is expedient for the treatment module to have a nozzle matrix.

The plant treatment device preferably detects movement information relative to the ground, in particular by means of the camera module and/or by means of a satellite navigation system and/or an additional speed sensor and/or at least an inertial sensor. The speed sensor is particularly preferably formed on/in a support wheel of the treatment module, which supports the plant treatment device, and wherein the support wheel rolls over the ground and on which a speed of the plant treatment device over the ground is simultaneously detected by means of at least one sensor element.

It is preferred for the plant treatment device to have at least one active illumination unit, particularly preferably comprising LEDs, in particular for the cameras.

It is expedient for the camera module to have two or three or more cameras, which are arranged in particular next to each other, wherein the cameras capture the plants in different wavelengths and/or spectra. Particularly preferably, at least two of the cameras are oriented at different angles relative to the ground.

The treatment module preferably has additional nozzles for applying and/or spraying foam.

It is preferred for the treatment module to have at least one chopping device, which processes the soil next to a detected plant row mechanically, in particular chops and/or scrapes and/or digs.

The plant treatment device is preferably arranged on a vehicle, in particular on a trailer which can be pulled by a tractor or fastened to a tractor.

The method advantageously comprises software or a computer program product, which is executed in particular on the electronic control unit ECU.

Preferably, the position of a single plant is recognised at the root base or the root base is located two-dimensionally on the ground or field.

The assessment or decision as to whether the individual plant being detected is a useful plant or non-cultivated plant is preferably made on the basis of stored plant differentiation parameters or plant information, in particular by means of the electronic control unit, expediently on the basis of the shape and/or structure and/or color of the respective plant.

Along the direction of movement of the plant treatment device above the ground, the camera module preferably moves first over the plants to be detected and then the treatment module.

Preferably, the at least one camera is arranged more than 0.4 m or substantially 1 m above the ground and the nozzles of the treatment module more than 0.05 m, in particular between 0.08 m and 0.1 m.

The at least one nozzle of the treatment module advantageously has a triangular outlet opening.

A vehicle is preferably understood to be a separate vehicle or alternatively preferably a vehicle trailer.

The camera module is suitably designed and is used in such a way that it detects one or more crop rows, and in particular, the fallow tracks adjacent to and/or between the crop rows.

Preferably, the method has been developed in such a way that a positive selection as a useful plant is carried out if a specific individual plant is not recognized.

### DESCRIPTION OF THE SEVERAL VIEWS OF THE DRAWINGS

FIG. 1 illustrates a plant treatment device

### DETAILED DESCRIPTION

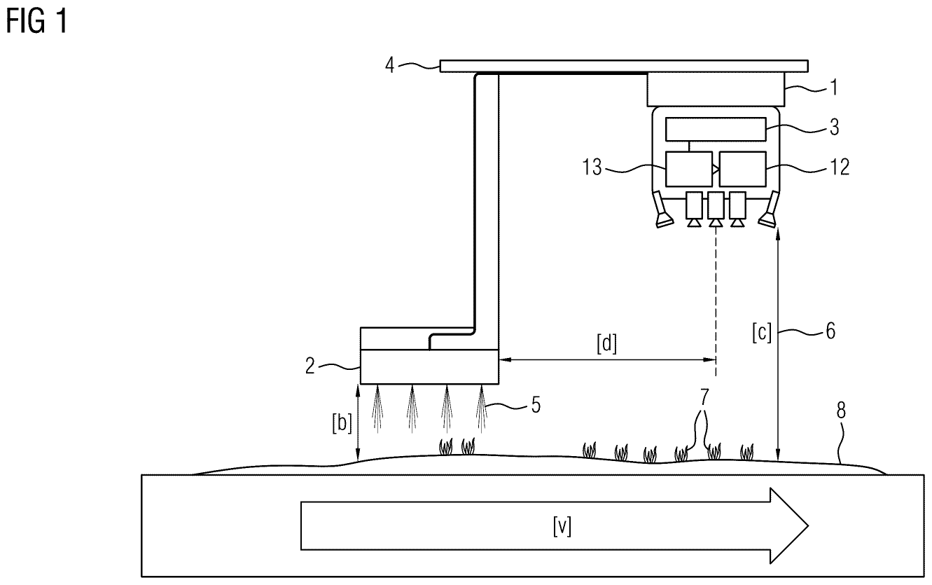

FIG. 1 illustrates schematically an embodiment of a plant treatment device which comprises at least one camera module 1 and at least one treatment module 2 and an electronic control unit 3.

The plant treatment device has a mounting frame 4 to which the treatment module 2 and the camera module 1 are attached.

The camera module 1 has several cameras 13 and illumination units 12, for example, formed as LEDs. At least two of the cameras have a different orientation with respect to the ground 8, over which the plant treatment device moves in the direction v. For example, cameras 13 capture a different spectrum/wavelength. The cameras are mounted or positioned, for example, at a height c, 6, approximately 1 m above the ground 8. The cameras detect the individual plants 7. With respect to the direction of movement v, the treatment module 2 is arranged at the distance d behind the camera module 1. The nozzles of the nozzle matrix of the treatment module 2 are arranged at the height b above the ground 8, for example at a height of 8 cm. In the event that a single plant 7 is identified and assessed as a non-cultivated plant, water 5 at more than 100° C. is sprayed onto the non-cultivated plant by means of the nozzles at a pressure of more than 1 bar.

1. A method for detecting and treating plants by means of a plant treatment device, the method comprising:
providing the plant treatment device that comprises:
at least one camera module and at least one treatment module; and
an electronic control unit;
capturing at least one image of at least one or more individual plants by the camera module,
after which, on the basis of the image of the at least one individual plant and by stored plant information, a decision is made in the electronic control unit for each individual plant detected as to whether this is a useful plant or a non-cultivated plant, and wherein at least one item of position information is assigned to this individual plant, after which, for each non-cultivated plant detected, applying and/or spraying a liquid onto the non-cultivated plant by at least one nozzle of the treatment module.

2. The method as claimed in claim 1, wherein the liquid comprises water at a temperature of at least 90° C., 100° C.

3. The method as claimed in claim 2, wherein the liquid additionally comprises a foam, which is biodegradable.

4. The method as claimed in claim 1, wherein the position information about each individual plant detected comprises two-dimensional position information and additional height information (b) of the treatment module above the ground on which the plants stand.

5. The method as claimed in claim 1, wherein the treatment module has a nozzle matrix.

6. The method as claimed in claim 1, wherein the plant treatment device detects movement information (v) relative to the ground by the camera module and/or by a satellite navigation system and/or an additional speed sensor and/or at least an inertial sensor.

7. The method as claimed in claim 1, wherein the plant treatment device has at least one active illumination unit for the cameras.

8. The method as claimed in claim 1, wherein the camera module has two or three or more cameras, which are arranged in particular side by side, wherein the cameras detect the plants in different wavelengths and/or spectra.

9. The method as claimed in claim 1, wherein the treatment module has additional nozzles for applying and/or spraying foam.

10. The method as claimed in claim 1, wherein the treatment module has at least one chopping device, which processes the soil beside a detected plant row mechanically, in particular chops and/or scrapes.

11. The method as claimed in claim 1, wherein the plant treatment device is arranged on a vehicle.

12. A plant treatment device comprising:
at least one camera module; and
at least one treatment module; and
an electronic control unit;
wherein the plant treatment device is designed to:
capture an image of a plant;
decide whether the plant is a useful plant or a non-cultivated plant;
assign position information to the plant; and
apply a liquid onto the plant based on whether the plant is the non-cultivated plant.

13. The device of claim 12, further comprising a mounting frame attached to the treatment module and the camera module.

14. The device of claim 13, wherein the treatment module is positioned at a lower height than the camera module.

15. The device of claim 12, wherein the treatment device is positioned at a height of about 8 cm and the camera module is positioned at a height of between 0.08 meter and 1 meter.

16. The device of claim 12, wherein the liquid is sprayed at a temperature exceeding 100 degrees Celsius and at a pressure of mor than 1 bar.

17. The device of claim 12, wherein the non-cultivated plant is a weed.

18. The device of claim 12, wherein the plant is of a crop row.

19. A method for detecting and treating plants by means of a plant treatment device, the method comprising:
providing a plant treatment device having a camera module, a treatment module, and an electronic control unit;
capturing at least one image of at least one or more individual plants by the camera module, after which, on the basis of the image of the at least one individual plant and by stored plant information, deciding whether this is a useful plant or a weed by the electronic control unit; and
applying a high temperature liquid at a temperature of at least 90 degrees Celsius onto the non-cultivated plant by at least one nozzle of the treatment module.
